(19) United States
(12) Patent Application Publication
(10) Pub. No.: US 2017/0297082 A1
(43) Pub. Date: Oct. 19, 2017

(54) Press for working during primary processing time

(71) Applicant: SK-Technologies GmbH, Aichhalden (DE)

(72) Inventor: Stefan Andreas Kruck, Aichhalden (DE)

(73) Assignee: SK-Technologies GmbH, Aichhalden (DE)

(21) Appl. No.: 15/518,386

(22) PCT Filed: Oct. 5, 2015
(86) PCT No.: PCT/EP2015/072968

§ 371 Date: Apr. 11, 2017

(30) Foreign Application Priority Data
Oct. 13, 2014 (DE) 10 2014 015 566.8
Oct. 22, 2014 (DE) 10 2014 015 543.9
Jan. 16, 2015 (DE) 10 2015 000 268.6
Apr. 29, 2015 (DE) 10 2015 005 410.4
Aug. 6, 2015 (DE) 10 2015 112 959.0

(51) Int. Cl. B21J 9/02; B30B 15/02; B21J 9/18; B30B 15/14; B30B 15/08

(52) U.S. Cl. CPC B21J 9/02; B30B 15/028; B21J 9/18; B21J 9/022; B30B 15/08; B30B 15/146

(57) ABSTRACT

A press comprising: at least one press ram by means of which a press stroke can be carried out when the press is actuated; at least one first working station and a second working station, wherein the first and the second working station each has a tool lower part and a tool upper part, wherein a first forming stage is formed by means of the tool lower part and the tool upper part of the first working station, and a second forming stage is formed by means of the tool lower part and the tool upper part of the second working station; and a mechanical element for transmitting the press stroke to one of the first or second forming stages, wherein the press stroke can be transmitted to the first and the second forming stages independently from one another.

The invention relates to a press according to the preamble of claim 1.

The invention relates to a press which is used in particular in a forging process. Forging processes are known in which a plurality of forming stages are used. Different forming stages are forged in successively disposed working stations while approaching the final contour in steps. In order to be able to manufacture economically, all forming stages are, if possible, arranged in one single press.

Depending upon the force of the press or other parameters of the forging process, all forming stages are occupied simultaneously. This occupation is referred to below as a multiple occupation process. If the force of the press is not sufficient or if other parameters of the forging process do not allow all forming stages to be occupied simultaneously, the process is shifted from one forming stage to the next. In this case only one forming stage is occupied at a time. This occupation is referred to below as a single occupation process.

The forging with a plurality of forming stages takes place with forging tools. If these tools have no mold contour, the process is known as free form forging. If a negative mold of the workpiece is introduced into the forging tool, the process is known as die forging.

In free form forging as well as in die forging it is necessary to wet the forging dies with a release agent. This wetting process is referred to as lubrication. The lubrication must generally be carried out after each forged component in the respective tool. In addition to the lubrication, a blowing out of the mold takes place which, in this case and in the following, is included in the lubrication process of the forging tools.

In the multiple occupation process the lubrication has a disadvantageous effect in that all workpieces of the different forming stages are removed from the forging tools, generally simultaneously, and all forging tools must be wetted. In known transfer beam systems this necessitates sufficient space between the forging tools, since the removed components are moved by the transfer beam system between the forging tools, in order then to free the space above or below the forging tool for corresponding lubricating tools. Likewise the lubrication cycle prolongs the cycle time.

In the single occupation process a lower productivity results from the process per se, since the forming stages are performed successively. With equal cycle times for each forming stage there is then, for example, a corresponding doubling of the cycle time. In addition it is disadvantageous that lubrication cannot be performed during the forging, since the lubricating tools are situated within the path of action of the forging tools.

The processing time of workpieces is designated as the primary time. In the case of operations during primary time, also referred to as concurrent with primary time, these operations should have no influence on the processing time of the workpieces. In forging operations on presses the time for the press forward stroke and return stroke is designated as the primary time.

In the known presses the problem arises that ancillary operations that are needed, such as for example lubrication, loading and unloading as well as cleaning of the forging tools, cannot be carried out during primary time. This is the starting point for the invention.

The object of the invention is to provide a press in which while one forming stage is carried out ancillary operations can be carried out at the other forming stages during the primary time in order in particular to shorten the cycle time.

The object of the invention is solved by a press with the features of claim 1.

Advantageous embodiments and modifications of the invention are set out in the dependent claims.

The press according to the invention is equipped with at least one press ram by means of which a press stroke can be carried out when the press is actuated, with at least one first working station and a second working station, wherein the first and the second working station each have a tool lower part and a tool upper part, wherein a first forming stage is formed by means of the tool lower part and the tool upper part of the first working station, and a second forming stage is formed by means of the tool lower part and the tool upper part of the second working station, and with a mechanical element for transmitting the press stroke alternately to one of the forming stages, wherein the press stroke can be transmitted to the first and the second forming stages alternately and independently of one another.

Due to the transmission of the press stroke to the first and the second forming stage independently of one another, while a press stroke is being carried out and transmitted to one of the forming stages ancillary operations can be carried out on the other forming stage during primary time.

The press preferably has a number n of forming stages, wherein the mechanical element can transmit the press stroke simultaneously to a number of 1 to n−1 forming stages. An ancillary operation can then be carried out at the remaining forming stage, which is advantageous in particular in the case of rotary transfer machines.

In an advantageous embodiment of the invention the mechanical element is controllable by at least one control element, preferably hydraulically or pneumatically. In each case a hydraulic or pneumatic control can be set particularly delicately, uniformly and continuously variably.

The at least one control element is advantageously arranged on the at least one press ram. This results in an advantageous space-optimized construction for the press.

In an alternative embodiment of the invention the at least one control element is arranged on a housing of the press and/or on a press table of the press. Thus an advantageous alternative is provided for the arrangement of the control element.

According to a preferred embodiment of the invention the at least one control element can be extended out of the at least one press ram, preferably simultaneously with the press stroke, wherein the control element can be extended with a low application of force, preferably by a spindle drive, and is locked in the extended position by positive engagement, preferably by a spindle pitch with self-locking.

Thus control can be guaranteed, for example, by means of the self-locking spindles extending out of the press ram in the direction of the forging tools. Extending cylinders, which can be locked in the extended position, meet this purpose. Due to these elements the mechanical element can be omitted. The press stroke is then transmitted to the tools by the press ram via these elements. Due to the locking by positive engagement or the self-locking, the control elements do not require a substantial application of force for extension and nevertheless can transmit the substantial force from the press ram to the forging tools.

In a further embodiment of the invention the at least one control element can be extended substantially perpendicularly to the press stroke. This is advantageous in particular when the at least one control element is arranged laterally on the housing of the press.

The control element is preferably a control cylinder. A control cylinder is particularly simple to control hydraulically or pneumatically.

Advantageously the mechanical element is a control plate or a control piston, which is suitably shaped and dimensioned to transmit the force of the press from the press ram to the respective tool. Plate-like elements or pistons are easily replaceable.

According to a preferred embodiment of the invention the press stroke can be controlled manually and/or automatically. In the case of presses in which the space conditions inside the tools are restricted due to the construction, manual operation of the press can be very awkward and may even be prohibited according to safety regulations. An automated control is then particularly advantageous. The press stroke can be controlled for example by a robot. The loading and unloading as well as ancillary operations can be carried out by a robot.

According to an advantageous embodiment of the invention the press stroke can be transmitted by the mechanical element to the tool upper part of the respective forming stage. The movement carried out by the press ram acts on the tool upper part of a forming stage so that the respective working station is closed and the at least one other working station is open, wherein a forging operation is carried out by the closed working station. Thus simultaneously with the primary time of the operation at the first working station, ancillary operations can be carried out at the second working station. For safety-related reasons a robot is preferably used in the transmission of the press stroke.

In a further development of the invention the tool upper part, to which no press stroke is transmitted, is held by retaining means in an open position. The tool upper part is advantageously held in the open position by the retaining means until force is introduced by means of the press ram and the mechanical element and the tool upper part and tool lower part are closed.

The retaining means are preferably arranged between the tool lower part and the tool upper part. This arrangement results in a particularly advantageous space-saving design of the press.

In an alternative embodiment of the invention the retaining means are arranged between the tool upper part and the press table. This arrangement is an advantageous alternative to the aforementioned arrangement of the retaining means.

The retaining means preferably have at least one compression spring. Spring elements which are known from mechanical engineering, and may be of simple construction such as spiral springs, cup springs or gas pressure springs, can be used as compression springs.

In a further embodiment of the invention the retaining means have at least one tension spring. Tension springs can provide better loading and unloading of the press. In particular, tension springs which are arranged between the tool upper part and the press table provide sufficient space between a tool upper part and a tool lower part.

Advantageously the press has communication means for controlling a robot and a lubrication device. The robot and the lubrication device can be controlled via the communication means depending upon the control of the press stroke. With lubrication devices, for example spray manipulators, friction between forging tool surfaces and workpieces can be reduced and demoldability can be set.

According to a preferred embodiment of the invention the press is a forging press or a trimming press. Depending upon the forging process, forged components have excess material peripherally which can be removed in separate trimming operations by means of a trimming press.

The invention is explained in detail with reference to the following drawings. In the drawings:

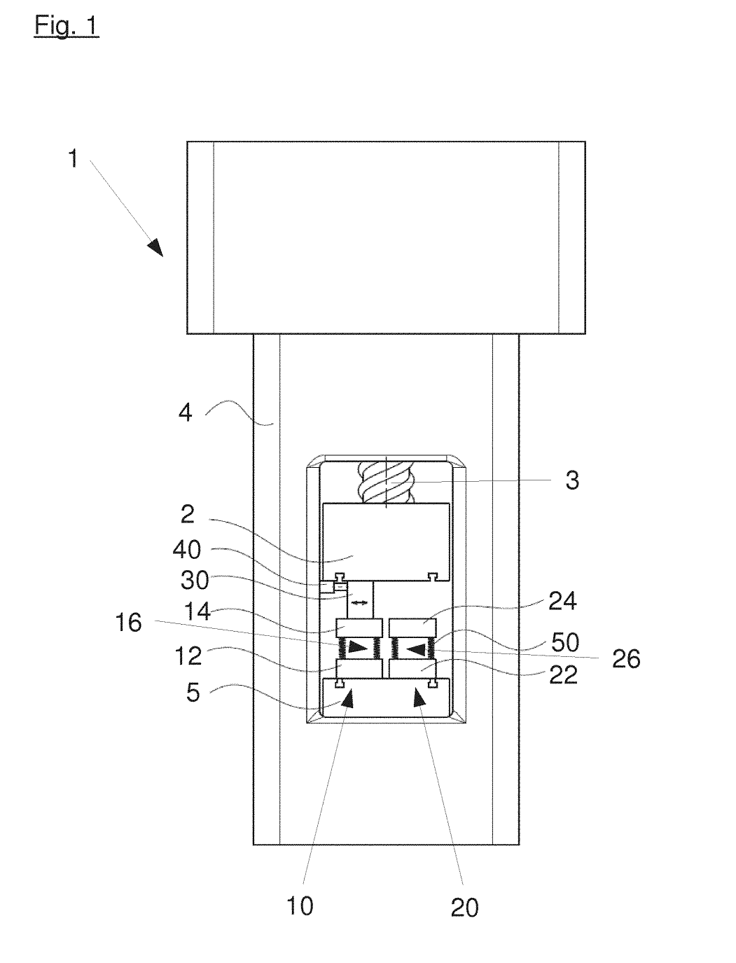

FIG. 1 shows a side view of an embodiment of a press,

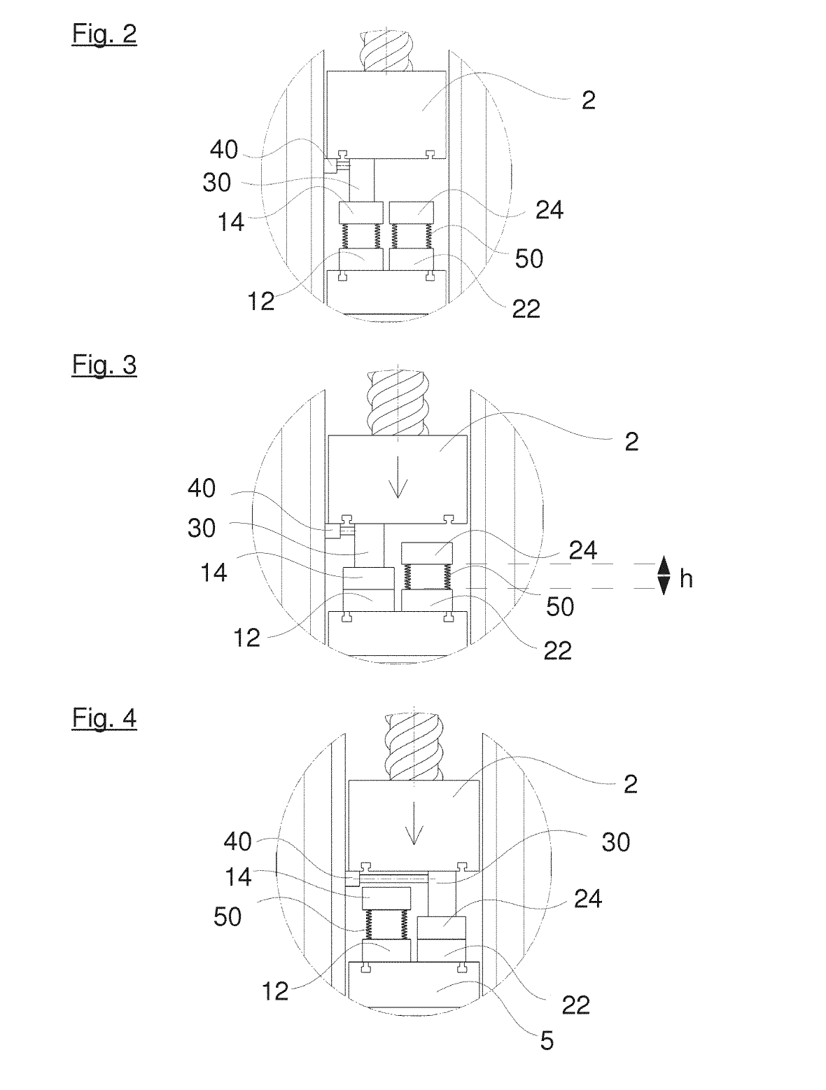

FIG. 2 shows a detail of the press according to FIG. 1 in the open position,

FIG. 3 shows a detail of the press according to FIG. 1 in the closed position,

FIG. 4 shows a detail of the press according to FIG. 1 in a further closed position,

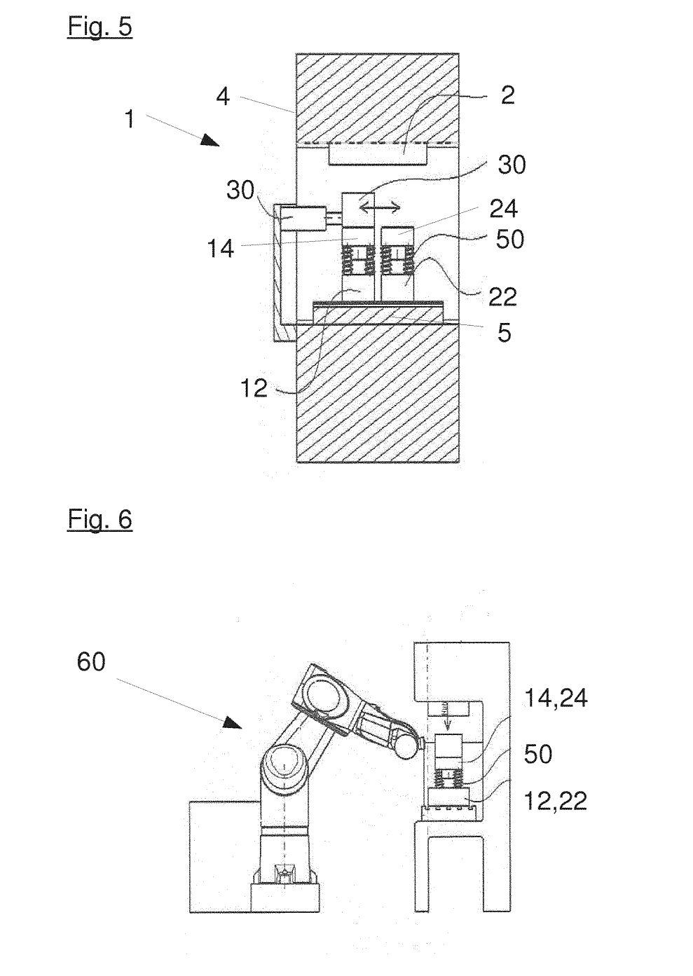

FIG. 5 shows a side view of a further embodiment of a press,

FIG. 6 shows a side view of a further embodiment of a press with a robot, and

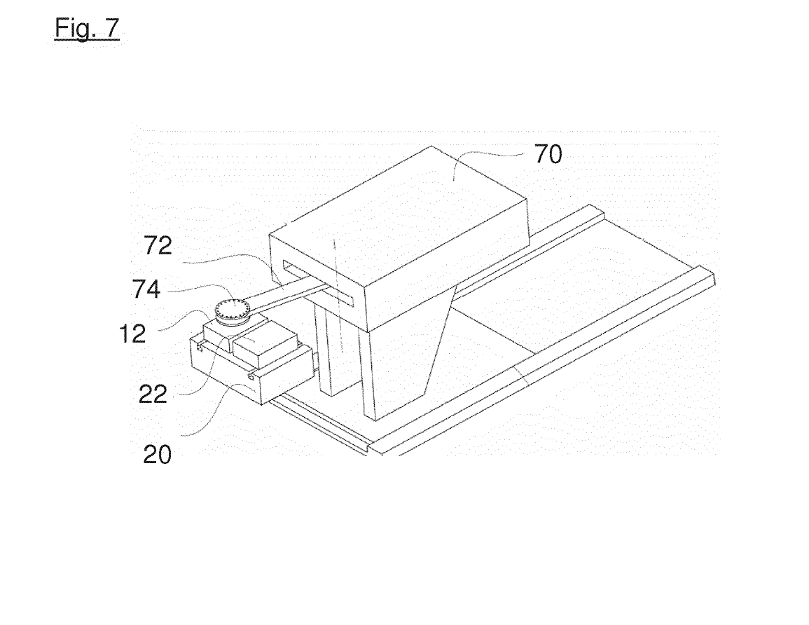

FIG. 7 shows a perspective view of an exemplary embodiment of a lubrication device.

In the drawings, unless stated otherwise, identical reference numerals designate identical reference parts with the same meaning.

FIG. 1 shows a side view of an exemplary embodiment of a press 1 according to the invention. The press 1 is arranged in a housing 4. The press 1 of FIG. 1 is a forging press which is driven by means of a spindle drive 3.

A press 1 with a spindle drive 3 is also designated as a spindle press. Spindle presses can be designed with a large stroke, since a rotary movement of a spindle can be converted into a vertically acting translation, the magnitude of which is dependent on the length of the spindle, in the axial direction of the spindle. The length of the stroke of a spindle press has hardly any effect on the purchase price. A long stroke is advantageous in particular in the case of large workpieces.

A press ram 2 is arranged at one end of the spindle drive 3. When the press 1 is actuated, the press ram 2 carries out a press stroke h, that is to say the press ram 2 travels a distance h in the axial direction of the spindle.

In the present case a first working station 10, which comprises a tool lower part 12 and a tool upper part 14, and a second working station 20, which comprises a tool lower part 22 and a tool upper part 24, are arranged on a press table 5 of the press 1. The tool lower parts 12, 22, above which the tool upper parts 14, 24 are arranged, are arranged directly on the press table 5. The tool lower parts 12, 22 and the tool upper parts 14, 24 respectively form a first forming stage 16 and a second forming stage 26.

A mechanical element 30 in the form of a control plate is arranged between the tool upper parts 14, 24 and the press ram 2. The mechanical element 30 is movable in the orthogonal direction with respect to the press stroke h by means of a control element 40, which in the present case is configured as a control cylinder and arranged on the press ram 2. Thus by means of the mechanical element 30, as a function of the movement of the control element 40, the press stroke h can be transmitted to one of the forming stages 16, 26 independently of one another.

The first working station 10 and the second working station 20 each have a retaining means 50. In the exemplary embodiment illustrated in FIG. 1 the retaining means 50 are configured as compression springs, of which in each case two are arranged between the tool lower part 12 and the tool upper part 14 of the first working station 10 and the tool lower part 22 and the tool upper part 24 of the second working station 20. In this case the retaining means 50 are configured as helical springs. The tool upper parts 14 and 24 are held in an open position by the spring action of the retaining means 50 until force is introduced by means of the press ram 2 and the mechanical element 30 and closing of one of the at least two working stations 10, 20 is implemented. Alternatively, the retaining means 50 can also be arranged between the tool upper part 14, 24 and the at least one press ram 2.

FIG. 2 shows an enlarged detail of the forging press from FIG. 1. In this case the press ram 2 is in the open position, i.e., a force is not introduced on any of the at least two working stations 10, 20. In the open position of the press ram 2 the retaining means 50 are not stressed by the press stroke h. The control element 40 is moved out in the orthogonal direction with respect to the press stroke h so far that the mechanical element 30 is arranged between the press ram 2 and the tool upper part 14 of the first working station 10.

FIG. 3 shows an enlarged detail of the forging press from FIG. 1, in which the press ram 2 is shown in a closed position. In the closed position a force is introduced into one of the at least two working stations 10, 20. The control element 40 is moved out in such a way that the mechanical element 30 is arranged between the press ram 2 and the tool upper part 14 of the first working station, so that when the press ram 2 is actuated a transfer of force can take place at the first working station 10 in order to be able to carry out a forging operation at the first working station 10. In the closed position of the press ram 2 the retaining means 50 are compressed between the tool upper part 14 and the tool lower part 12 of the first working station 10 by the force of the press 1. In the case of compression springs, the compression springs of the first working station 10 are compressed by the mechanical element 30 which transmits the press stroke h of the press ram 2 to the first working station 10, so that a forging operation can be carried out at the first working station 10. The second forming stage 26 is held in an open position by the retaining means 50.

FIG. 4 shows a further enlarged detail of a forging press from FIG. 1, in which the press ram 2 is shown in a closed position as in FIG. 3. In contrast to FIG. 3, the control element 40 is moved out in such a way that the mechanical element 30 is arranged between the tool upper part 24 of the second working station 20 and the press ram 2. In this case the retaining means 50 are compressed between the tool upper part 24 and the tool lower part 22 of the second working station 20, which are for example configured as compression springs, by the mechanical element 30 which transmits the press stroke h of the press ram 2 to the tool upper part 24 of the second working station 20, so that a forging operation can be carried out at the second working station 20. The first forming stage 16 is held in an open position by the retaining means 50.

In FIGS. 3 and 4 it is shown how the press stroke h of the press ram 2 can be transmitted to the first and the second forming stage 16, 26 independently of one another. In this case at one of the forming stages 16, 26 which is now situated in an open position, an ancillary operation, for example lubrication, can be carried out on the respective tool lower parts 12, 22 and tool upper parts 14, 24. Thus simultaneously with the primary time of the operation at a closed forming stage 16, 26, ancillary operations can be carried out at a respective open forming stage 16, 26. Due to safety regulations such ancillary operations by human intervention are hardly allowed. An error in the control of the control element could have life-threatening consequences. Therefore for carrying out the ancillary operations automated process equipment is advantageously used which is integrated in the control sequence.

For example, a robot 60 can be employed, cf. FIG. 6. The robot 60 can be controlled via communication means of the press 1, wherein the robot 60 is controllable depending upon the control of the press stroke h.

The lubrication device 70 illustrated in FIG. 7 is a so-called spray manipulator with a traversing arm 72, at one end of which a spray head 74 is arranged. The traversing arm 72 can be rotated about an axis of rotation, in order to reach the forming stages 16 and 26. However, linear movements of the traversing arm 72 are also possible. The spray heads 74 can be adapted to different contours of the different forming stages 16 and 26. The lubrication device 70 can be controlled via communication means of the press 1, wherein the lubrication device 70 is controllable depending upon the control of the press stroke h.

FIG. 5 shows a side view of an exemplary embodiment of a press 1, in which the control element 40 is arranged laterally on the press ram 2 on the housing 4. The mechanical element 30 is arranged in the housing 4, between the press ram 2 and the tool upper parts 14, 24.

It is within the scope of the invention that the press can be a forging press, a trimming press or some other press.

Likewise it is within the scope of the invention that the control element 40 can be extended out of the press ram 2, preferably in a direction parallel to the press stroke h, wherein the control element 40 can be locked by positive engagement or can be retained by means of self-locking. Thus control can be guaranteed, for example, by means of self-locking spindles extending out of the press ram 2 in the direction of the tool upper parts 14, 24. Extending cylinders, which can be locked by positive engagement in the extended position, meet this purpose. Thus cylinders or spindles form the control elements 40. Due to these elements the mechanical element 30 can be omitted. The force is then transmitted by the press ram 2 via these elements to the tool upper parts 14, 24. Due to the locking by positive engagement or the self-locking, the control elements 40 do not require a substantial application of force for extension and nevertheless can transmit the substantial force from the press ram 2 to the tool upper parts 14, 24.

Likewise it is within the scope of the invention that the retaining means 50 are arranged between the press table 5 and the tool upper part 14, 24, so that the retaining means 50 in the form of spring elements could apply a spring force between the press table and the tool upper parts 14, 24. In this case sufficient space is provided between the tool upper parts 14, 24 and the tool lower parts 12, 22.

### LIST OF REFERENCES

1 press
2 press ram
3 spindle drive
4 housing
5 press table
10 working station
12 tool lower part
14 tool upper part
16 forming stage
20 working station
22 tool lower part
24 tool upper part
26 forming stage
30 mechanical element
40 control element
50 retaining means
60 robot
70 lubrication device
72 traversing arm
74 spray head
h press stroke

1. A press comprising:
a press ram configured to carry out a press stroke when the press is actuated;
a first working station comprising a first tool lower part and a first tool upper part;
a second working station comprising a second tool lower part and a second tool upper part;
a first forming stage comprising the first tool lower part and the first tool upper part of the first working station;
a second forming stage comprising the second tool lower part and the second tool upper part of the second working station;
a mechanical element for transmitting the press stroke to one of the first forming stage or the second forming stage,
wherein the press stroke can be transmitted to the first forming stage and the second forming stage independently from one another.

2. The press according to claim 1,
further comprising a number n of forming stages, wherein the mechanical element can transmit the press stroke simultaneously to a number of 1 to n−1 forming stages.

3. The press according to claim 1,
further comprising a control element that controls the mechanical element.

4. The press according to claim 3,
wherein the control element is arranged on the press ram.

5. The press according to claim 3,
wherein the control element is arranged on a press housing.

6. The press according to claim 3,
wherein the control element can be extended out of the press ram, simultaneously with the press stroke,
wherein the control element can be extended with a low application of force, and is locked in an extended position by positive engagement.

7. The press according to claim 3,
wherein the control element can be extended substantially perpendicularly to the press stroke.

8. The press, according to claim 3 wherein the control element is a control cylinder.

9. The press according to claim 1, wherein the mechanical element is selected from the group consisting of a control plate and a control piston.

10. The press according to claim 1,
wherein the press stroke can be controlled manually or automatically.

11. The press according to claim 1,
wherein the press stroke can be transmitted by the mechanical element to a single tool upper part of a single particular forming stage.

12. The press according to claim 1,
wherein a single tool upper part, to which no press stroke is transmitted, is held by retaining member in an open position.

13. The press according to claim 12,
wherein a single retaining member is arranged between a single tool lower part and a single tool upper part.

14. The press according to claim 12,
wherein the single retaining member is arranged between a single tool upper part and the press table.

15. The press according to claim 12,
wherein the retaining member has a compression spring.

16. The press according to claim 12,
wherein the retaining member has a tension spring.

17. The press according to claim 1,
wherein the press has a communication element for controlling a robot and a lubrication device.

18. The press according to claim 1,
wherein the press is selected from the group consisting of a forging press and a trimming press.

19. A press, comprising:
a press ram configured to carry out a press stroke when actuated;
a plurality of working stations opposite the press ram, each working station of the plurality of working stations comprising a tool lower part and a tool upper part that form a forming stage;
a mechanical element for transmitting the press stroke to a single forming stage independently from another forming stage; and
a control element located on the press ram that moves the mechanical element.
